(19) United States
(12) Patent Application Publication
(10) Pub. No.: US 2023/0055188 A1
(43) Pub. Date: Feb. 23, 2023

(54) SYSTEMS AND METHODS FOR KNOWLEDGE BASE QUESTION ANSWERING USING GENERATION AUGMENTED RANKING

(71) Applicant: salesforce.com, inc., San Francisco, CA (US)

(72) Inventors: Xi Ye, Austin, TX (US); Semih Yavuz, Redwood City, CA (US); Kazuma Hashimoto, Menlo Park, CA (US); Yingbo Zhou, Palo Alto, CA (US)

(21) Appl. No.: 17/565,215

(22) Filed: Dec. 29, 2021

Related U.S. Application Data
(60) Provisional application No. 63/235,453, filed on Aug. 20, 2021.

(51) Int. Cl. G06N 5/04; G06N 5/02; G06F 16/2457

(52) U.S. Cl. CPC G06N 5/04; G06N 5/02; G06F 16/24578

(57) ABSTRACT

Embodiments described herein provide a question answering approach that answers a question by generating an executable logical form. First, a ranking model is used to select a set of good logical forms from a pool of logical forms obtained by searching over a knowledge graph. The selected logical forms are good in the sense that they are close to (or exactly match, in some cases) the intents in the question and final desired logical form. Next, a generation model is adopted conditioned on the question as well as the selected logical forms to generate the target logical form and execute it to obtain the final answer. For example, at inference stage, when a question is received, a matching logical form is identified from the question, based on which the final answer can be generated based on the node that is associated with the matching logical form in the knowledge base.

### CROSS REFERENCE(S)

The instant application is a nonprovisional of and claim priority under 35 U.S.C. 119 to U.S. provisional application No. 63/235,453, filed Aug. 20, 2021, which is hereby expressly incorporated by reference herein in its entirety.

This application is related to U.S. nonprovisional application Ser. No. ______ (attorney docket no. 70689.180US02), filed on the same day, which is hereby expressly incorporated by reference herein in its entirety.

### TECHNICAL FIELD

The embodiments relate generally to machine learning systems and question answering models, and more specifically to a mechanism for generation augmented iterative ranking for knowledge base question answering.

### BACKGROUND

Question answering models have been widely used in various applications and industries. For example, a virtual research agent may interact with an individual to help find answers for a research question asked by the individual. Modern knowledge base can serve as a reliable source of huge amount of world knowledge but may be difficult to interact with, as such database is extremely large in scale and often requires designated tools (e.g., sparql query, etc.) to access. Some existing question answering over knowledge base attempt to query over the knowledge base to generate an answer to an input question. However, users may often want to ask questions involving unseen composition or schema items, which cannot be accomplished by the existing systems.

Therefore, there is a need to provide a knowledge based question answering system that can handle unseen compositions.

### BRIEF DESCRIPTION OF THE DRAWINGS

FIG. 1 is a simplified diagram illustrating an example ranking of logical form candidates, according to one embodiment described herein.

FIG. 2A is a simplified diagram illustrating an example architecture of a knowledge base question answering system, and FIG. 2B shows a specific example of operating the knowledge base question answering system in FIG. 2A, according to one embodiment described herein.

FIG. 3 provides an example block diagram illustrating an example structure of the ranking model shown in FIGS. 2A-2B, according to one embodiment described herein.

FIG. 4 is a simplified block diagram illustrating an example structure of the generation module shown in FIGS. 2A-2B, according to embodiments described herein.

FIG. 5 is a simplified diagram illustrating an aspect of entity disambiguation by the ranking model, according to one embodiment described herein.

FIG. 6 is a simplified diagram of a computing device that implements the generation augmented iterative ranking for knowledge base question answering, according to some embodiments described herein.

FIG. 7A is a simplified logic flow diagram illustrating an example process of knowledge base question answering using the framework shown in FIGS. 2A-2B, according to embodiments described herein.

FIG. 7B is a simplified logic flow diagram illustrating an example process of entity disambiguation, according to embodiments described herein.

FIG. 8 is a simplified logic flow diagram illustrating an example process of training the framework in FIGS. 2A-2B for knowledge base question answering, according to embodiments described herein.

FIGS. 9-14 provide various data tables and plots illustrating example performance of the knowledge base question answering system and/or method described in FIGS. 1-8, according to one embodiment described herein.

In the figures, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

A knowledge base is a large collection of knowledge data comprising objects information and relationship information between the objects. Such knowledge base can often be searched upon to provide an answer to a query. Existing knowledge based question answering systems may achieve desirable performance with independent and identically distributed (I.I.D) data but cannot generalize to questions involving unseen knowledge base schema items with decent performance. For example, traditional ranking-based approaches, which usually generate a set of candidate logical forms from the knowledge base using pre-defined rules and then select the best-scored one, may often fail to exhaust all the rules to find the desired local form due to the large scale of the knowledge base. As a result, the traditional ranking approaches may often fail to answer some questions by only selecting one candidate from the enumerated set of candidates.

Embodiments described herein provide a question answering approach that answers a question by generating an executable logical form to be applied on the knowledge base. First, a ranking model is used to select a set of related logical forms from a pool of logical forms obtained by searching over a knowledge graph. The selected logical forms are semantically coherent and aligned with the underlying intents in the question and final desired logical form. Specifically, the selected logical forms are ranked based on their relevance. Next, a generation model is adopted conditioned on the question as well as the selected logical forms to generate the target logical form. The generated target logical form is then being used as a search query schema on the knowledge base to obtain the final answer.

For example, at inference stage, when a question is received, a matching logical form is identified from the question, based on which the final answer can be generated based on the node that is associated with the matching logical form in the knowledge base. In this way, the ranking model and the generation model may interact such that the ranking model provides essential information of knowledge base schema items to the generating model, which then further refines the top-candidates by complementing missing constructions or constraints, and hence allows covering a broader range of logical form space.

In one embodiment, the ranking model and the generation model may be built on pre-trained language models for generalization capability. For example, the ranking model may be built on a BERT-based bi-encoder that takes as input a question-candidate pair, which has been trained to maximize the scores of ground truth logical form candidates while minimizing the scores of incorrect candidates. Such training schema allows learning from the contrast between the candidates in the entire territory. An iterative-bootstrap-based training curriculum is adopted for efficiently train the ranker to distinguish spurious candidates.

For another example, the generation model may be a T5-based seq-to-seq model that fuses semantic and structural information found in the top-K candidates from the ranking model to compose the final logical form. Specifically, the generation model may an input of the question followed by a linearized sequence of the top-k candidates. The generation model may then distill a refined logical form from the top-K candidate logical forms conditioned on the question. In this way, the distilled logical form may better reflect the question intent by complementing the missing pieces or discarding the irrelevant parts without having to learn the low-level dynamics.

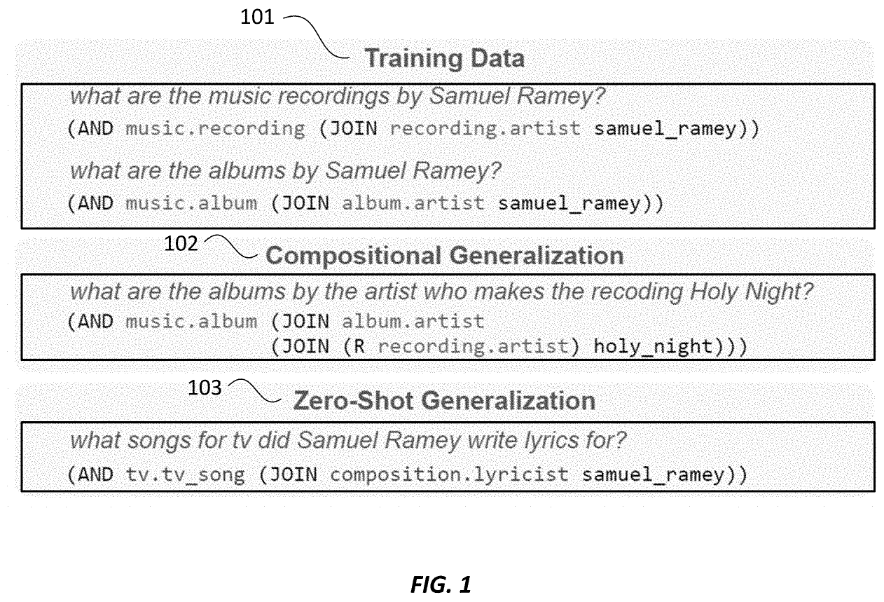

FIG. 1 is a simplified diagram illustrating an example of question generalization involving unseen composition or schema items, according to one embodiment described herein. As shown in FIG. 1, input questions are represented in logical forms such as an s-expression to represent queries over knowledge base. A s-expression uses functions (e.g., JOIN, AND, etc.) operating on set-based semantics and eliminates variable usages. This makes s-expression a suitable representation for the task of knowledge base question answering because such expression balances readability and compactness.

For example, questions such as “what are the music recordings by Samuel Ramey” or “what are the albums by Samuel Ramey” may be included in the training data 101 for a knowledge base question answering system. With the question in the training data 101, the knowledge base question answering system has learnt schema items such as “music.recordings” and “recording.artist.” Examples of compositional generalization 101 to new composition of schema items seen in the training data 102 may be a question “what are the albums by the artist who makes the recording Holy Night?” This new question involves schema items “music.recordings” and “recording.artist” that the question answering system has seen from the training data.

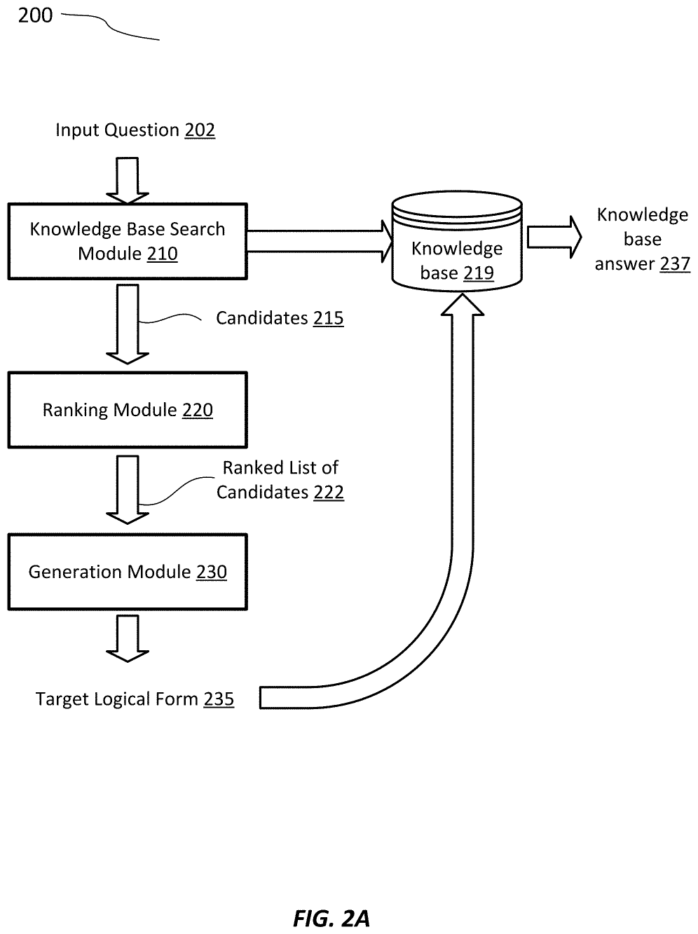

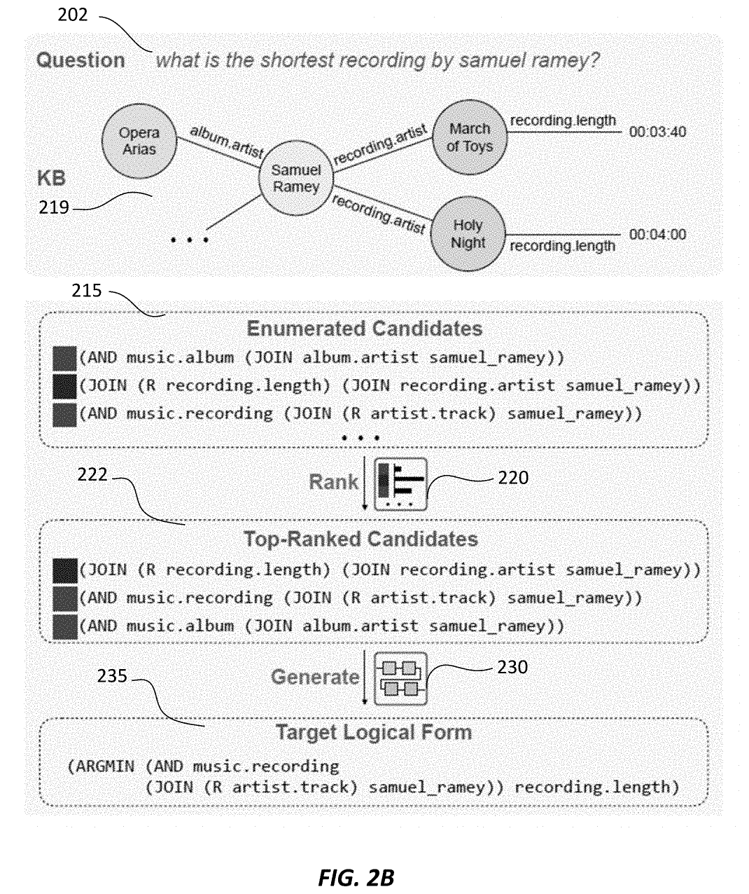

However, for a zero-shot generalization 103 “what songs for TV did Samuel Ramey write lyrics for,” as the new question changes dramatically in its compositions, the question includes unseen schema items “tv.tv_song” and “composition.lyricist,” which have not been seen from the training data. Such new composition with unseen schema items may be processed by the system introduced in FIG. 2.

FIG. 2A is a simplified diagram illustrating an example architecture of a knowledge base question answering system, and FIG. 2B shows a specific example of operating the knowledge base question answering system in FIG. 2A, according to one embodiment described herein. Diagram 200 shows a network architecture including a knowledge-base search module 210, a knowledge base database 219, a ranking module 220 and a generation module 230.

An input question x 202 may be received by question answering system at the knowledge-base search module 210. For example, as shown in FIG. 2B, the input question 202 may be a natural language question “what is the shortest recording by Samuel Ramey?” A task of the question answering system is to obtain a logical form y that can be executed over the knowledge base 219 to yield the final answer to the input question 202. The knowledge-base search module 210 may first search the knowledge base 219 for a set of candidate logical forms 215, denoted by {cᵢ}ᵢ₌₁^{m}.

Specifically, the knowledge base 219 may includes a collection of knowledge data stored in the form of subject-relation-object triple (s, r, o), where s is an entity, r is a binary relation, and o can be entities or literals (e.g., date time, integer values, etc.). For example, as shown in FIG. 2B, the example knowledge base 219 may take a form of a knowledge graph having a number of nodes, each representing a knowledge entity. The edges connecting the nodes in the knowledge graph may represent a relationship between the two connected nodes.

In one embodiment, the knowledge-base search module 210 may search the knowledge base 219 by starting from every entity detected in the question and query the knowledge base 219 for paths reachable within two hops. For example, as shown in FIG. 2B, starting form the entity “Samuel Ramey” detected in the question 202, the search module 210 may iterate all paths reachable within two hopes from the entity “Samuel Ramey,” such as edge “recording.artist”+node “March of Toys”+edge “recording.length”, or edge “recording.artist” +node “Holy Night”+edge “recording.length,” and/or the like.

Next, the search module 210 may convert each searched path to an s-expression, which constitutes the set of candidates 215. It is noted that this procedure for enumerating candidates 215 does not exhaust all the possible compositions (e.g., comparative operations and argmin/max operations are not included), and hence does not guarantee to cover the target s-expression. A more comprehensive enumeration method covering a broader range of s-expressions is possible but will introduce a significantly larger number (e.g., greater than 2,000,000 for some queries) of candidates. Therefore, it might not be computationally practical to enumerate every possible logical form when searching on the knowledge base 219.

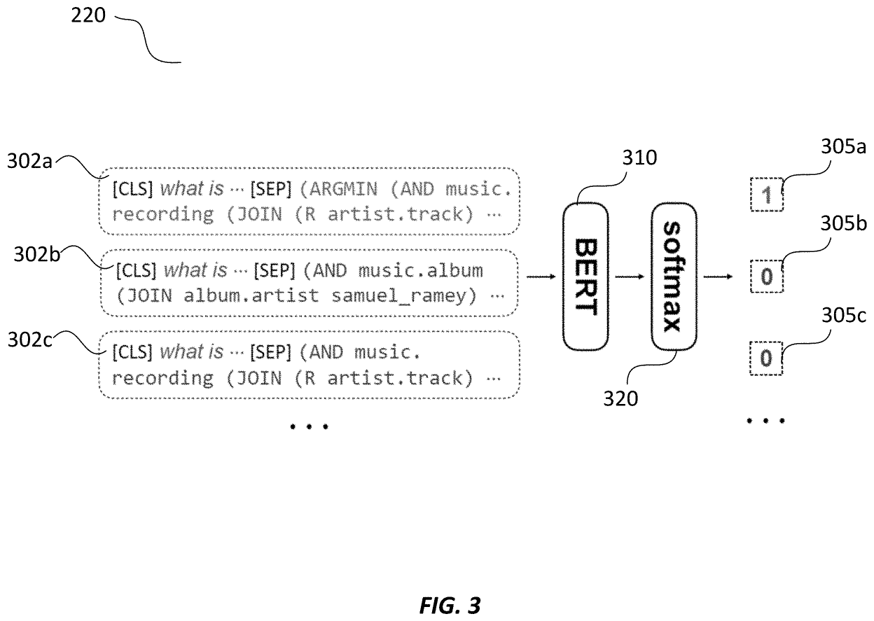

The list of candidate logical forms 215 may then be sent to a ranking module 220, which may be built on a BERT-based bi-encoder. FIG. 3 provides an example block diagram illustrating an example structure of the ranking model 220, according to one embodiment described herein. For example, the ranking module 220 may comprise a language model based bi-encoder (e.g., BERT 310 shown in FIG. 3), a linear projection layer, and an optional softmax module 320.

The ranking module 220 is trained to score each candidate logical form 215 via contrastive learning. Specifically, the ranking module 220 is trained to maximizes the similarity between the input question 202 and a ground truth logical form while minimizing the similarities between the question and the negative logical forms.

For example, given the question x 202 and a logical form candidate c from the set of candidates 215, a BERT-based encoder of the ranking module 220 takes as input the concatenation of the question and the logical form, e.g., as shown by the concatenated inputs 302a-c, which are input to the BERT encoder 310. A logit representing the similarity between the question and the logical form is formulated as follows:

s(x,y)=LINEAR(BERTCLS([x;y]))

where BERTCLS denotes the [CLS] representation of the concatenated input; LINEAR is a projection layer reducing the representation to a scalar similarity score.

In one embodiment, a softmax module 320 may optionally be used to generate a binary output from the similarity score, indicating whether the question and a specific logical form that has been concatenated with the question in an input are the right match. For example, the positive output 305a indicates that the question 202 and the logical form in input 302a is the right match. Otherwise, the negative outputs 305b-c indicate that the question 202 and the logical forms in inputs 302b-c are not the right match.

At training, the ranking module 220 is then optimized to minimize the following contrastive loss function:

$${ℒ}_{ranker} = \frac{{e}^{s ( x , y )}}{{e}^{s ( x , y )} + {\sum }_{c ∈ C ∧ c \neq y} {e}^{s ( x , c )}}$$

which aims at promoting the ground truth logical form while penalizing the negative ones via a contrastive objective. In contrast, traditional ranking models is a seq-to-seq model, which directly maps the question to target logical form, only leveraging supervision from the ground truth. Consequently, the ranking module 220 is more effective in distinguishing the correct logical forms from spurious ones (similar but not equal to the ground truth ones).

In one embodiment, due to the large number of candidates and limited GPU memory, it is impractical to feed all the candidates c∈C when training the ranking module 220. Therefore, a subset of negatives logical forms C′∠C are sampled at each batch in the training phase. One way for sampling negative logical forms is to draw random samples. However, because the number of candidates is often relatively large compared to the allowed size of negative samples in each batch, it may not be possible to cover spurious logical forms within the randomly selected samples.

Another way to sample negative logical forms is by bootstrapping. First, the ranking module 220 is trained using random samples for several epochs to warm start the training, and then the spurious logical forms that are confusing to the model are chosen as the negative samples for further training. In this way, the ranking module 220 can benefit from this advanced negative sampling strategy compared to using random negative samples.

Referring back to FIGS. 2A-2B, in one embodiment, the ranking module 220 may rank the list of candidates 222 based on the generated scores. The ranked list of candidates 222 are then fed to the generation module 230 to compose the final logical form conditioned on the question and the top-k logical forms. For example, the generation module 230 may be a transformer-based seq-to-seq model (as further described in Vaswani et al., Attention is all you need, in Advances in Neural Information Processing Systems, 2017 and Raffel et al., Exploring the limits of transfer learning with a unified text-to-text transformer, Journal of Machine Learning Research, 21(140):1-67, 2020), as such model demonstrates strong performance in generation-related tasks.

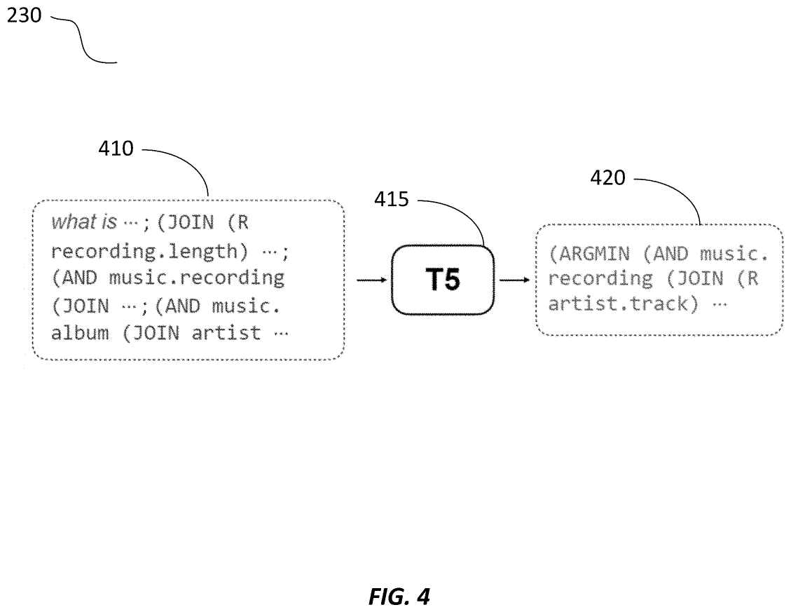

FIG. 4 is a simplified block diagram illustrating an example structure of the generation module 230, according to embodiments described herein. As shown in FIG. 4, the generation model 230 may comprise a transformer-based sequence-to-sequence model such as T5 415. The inputs 410 to the generation module 230 are constructed by concatenating the question and the top-k candidates returned by the ranking module 220 separated by semi-colon (i.e., [x; cₜ_{₁}; . . . ; cₜ_{ₖ}]). In response to the input, the generation module 230 may generate a target logical form 420, which is compared with the ground truth logical form token by token to compute a cross-entropy objective. The cross-entropy objective is then used to update the T5-based seq-to-seq model.

During inference, the ranking module 220 may adopt beam-search to autoregressively decode top-k target logical forms in the ranked list of candidates 222. To construct the top-k logical form candidates needed for training the generation module 230, the ranking module 220 may first be trained, and then use the rankings the ranked list 222 the ranking module 220 produces as the training data for the generation module 230.

As the generation model 230 can now leverage both the question 202 and knowledge base schema information (contained in the ranked candidates 222), the context is much more specified as compared to only conditioning on the question. This enables the generation module 230 to leverage the training data more efficiently by focusing only on correcting or supplementing existing logical forms instead of learning both the generation rules and correct logical forms.

Referring back to FIG. 2A, in one embodiment, the generation module 230 may generate the target logical form 235, which is executed on the knowledge base 219 to result in the knowledge base answer 237 in response to the question 202.

In some embodiments, the generation module 230 may include a vanilla T5 generation model without syntactic constraints, which does not guarantee the syntactic correctness nor executability of the produced logical forms. Therefore, at inference stage, an execution-augmented inference procedure may be adopted. Specifically, the top-k logical forms are decoded using beam search and then each logical form is executed on the knowledge base 219 until one that yields a valid (non-empty) answer is found. In case that none of the top-k logical forms is valid, the top-ranked candidate obtained using the ranking module 220 is outputted as the final logical form, which is guaranteed to be executable. This inference schema can ensure finding one valid logical form for each problem. In another implementation, a more complex mechanism may be incorporated to control the syntactic correctness in decoding (e.g., using grammar-based decoder described in Rabinovich et al., Abstract syntax networks for code generation and semantic parsing, in Proceedings of the Annual Meeting of the Association for Computational Linguistics (ACL), 2017) or dynamical beam pruning techniques (described in Ye et al., Benchmarking multimodal regex synthesis with complex structures, in Proceedings of the An-nual Meeting of the Association for Computational Linguistics (ACL), 2020)).

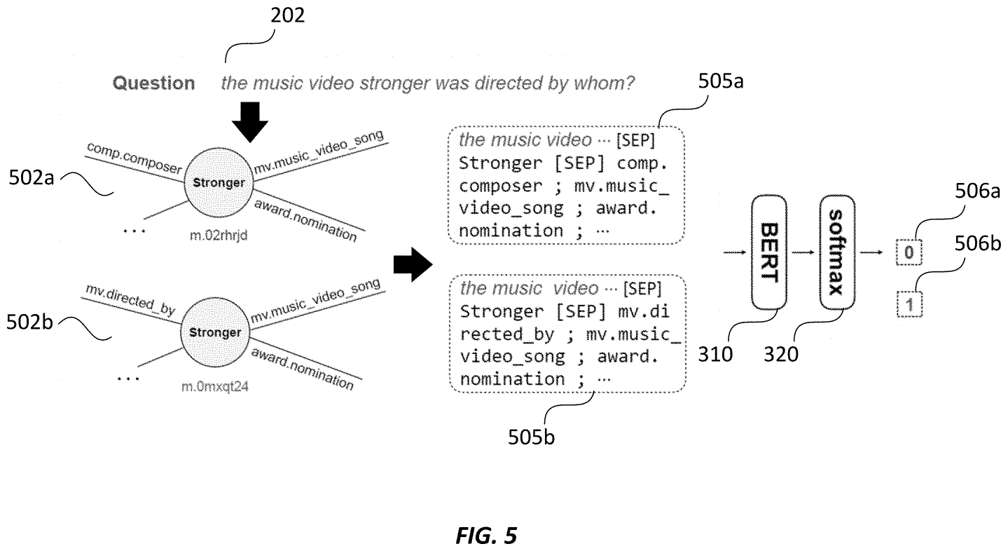

FIG. 5 is a simplified diagram illustrating an aspect of entity disambiguation by the ranking model, according to one embodiment described herein. In one embodiment, the ranking module 220 shown in FIG. 2A is configured for the task of ranking candidate logical forms. Here, the ranking module 220 may be adapted for the task of entity disambiguation. One way of finding knowledge entities referred in a question is to first detect the entity mentions with a named entity recognition (NER) system and then run fuzzy matching based on the surface forms. This paradigm has been previously employed in various methods such as those described in Yih et al., Semantic parsing via staged query graph generation: Question answering with knowledge base, in Proceedings of the 53rd Annual Meeting of the Association for Computational Linguistics and the 7th International Joint Conference on Natural Language Processing (Volume 1: Long Papers), 2015; Sun et al., PullNet: Open domain question answering with iterative retrieval on knowledge bases and text, in Proceedings of the 2019 Conference on Empirical Methods in Natural Language Processing and the 9th International Joint Conference on Natural Language Processing (EMNLP-IJCNLP), 2019; Chen et al., ReTraCk: A flexible and efficient framework for knowledge base question answering, in Proceedings of the 59th Annual Meeting of the Association for Computational Linguistics and the 11th International Joint Conference on Natural Language Processing: System Demonstrations, 2021; Gu et al., Beyond i.i.d.: Three levels of generalization for question answering on knowledge bases, 2021). However, this existing paradigm has a problem with entity disambiguation: a mention in the question usually matches surface forms of more than one entities in the knowledge base.

Existing approaches to disambiguate the matched entities may include choosing the most popular matched entity according to the popularity score provided by FACC1 project (as described in Chen et al., 2021; Gu et al., 2021). For example, as shown in FIG. 5, consider the question “the music video stronger was directed by whom?” taken from GRAILQA, where the most popular matched entity is “Stronger” (m.02rhrjd, song by Kanye West)” and the second is also “Stronger” (m.0mxqqt24, music video by Britney Spears). Thus, the surface form matching and popularity scores do not provide sufficient information needed for entity disambiguation.

Instead, the ranking module 220 may leverage the relation information linked with an entity to further help assess if it matches a mention in the question 202. For example, the question 202 mentions the entity “stronger,” based on which the ranking module 220 may find a possible candidate m.02rhrjd 502a and m.0mxqt24 502b in the knowledge base, both pointing to “stronger.” However, by querying relations over knowledge base, a relationship about my director mv.directed may be established by linking to m.0mxqqt24 at 505a, but there are no such kind of relations connected with m.02rhrjd at 505b. Therefore, the disambiguation problem may be cast as an entity ranking problem, and the ranking model 220 can be adapted to tackle this problem. For example, given a mention in the question 202, the question 202 is concatenated with the relations for each entity candidate matching the mention, e.g., as concatenated input 505a or 505b.

The same model architecture and loss function described in relation to the ranking module 220 can be reused to train another entity disambiguation model to further improve the ranking of the target entity. For example, the concatenated input 505a or 505b is input to the BERT module 310 and the softmax 320 in the ranking model to generate a binary output indicating whether the respective input contains the correct match or not. In this example, a negative output 506a shows the question 202 does not match with the first entity candidate 502a, but the positive output 506b shows the question 202 matches with the second entity candidate 502b instead.

### Computing Environment

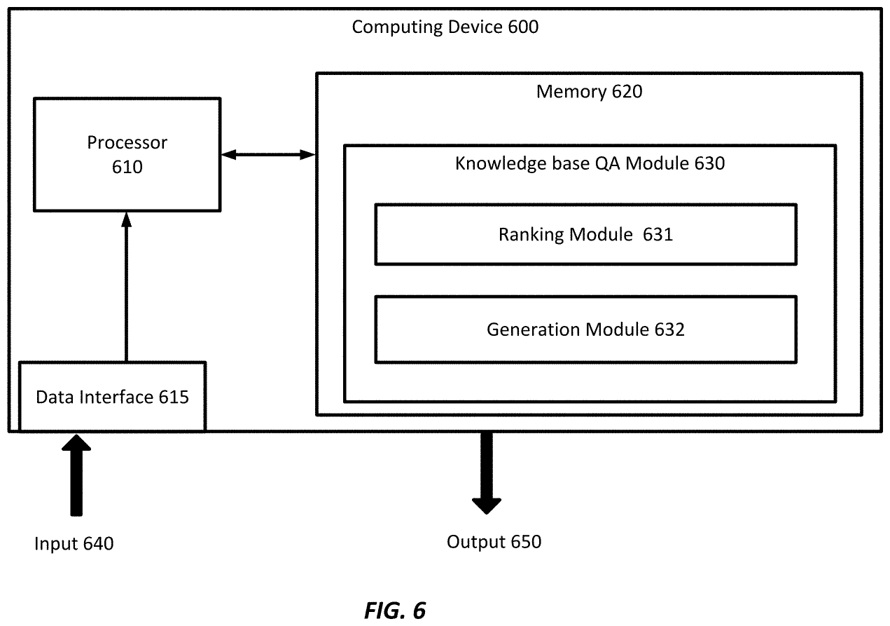

FIG. 6 is a simplified diagram of a computing device that implements the generation augmented iterative ranking for knowledge base question answering, according to some embodiments described herein. As shown in FIG. 6, computing device 600 includes a processor 610 coupled to memory 620. Operation of computing device 600 is controlled by processor 610. And although computing device 600 is shown with only one processor 610, it is understood that processor 610 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 600. Computing device 600 may be implemented as a stand-alone subsystem, as a board added to a computing device, and/or as a virtual machine.

Memory 620 may be used to store software executed by computing device 600 and/or one or more data structures used during operation of computing device 600. Memory 620 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 610 and/or memory 620 may be arranged in any suitable physical arrangement. In some embodiments, processor 610 and/or memory 620 may be implemented on a same board, in a same package (e.g., system-in-package), on a same chip (e.g., system-on-chip), and/or the like. In some embodiments, processor 610 and/or memory 620 may include distributed, virtualized, and/or containerized computing resources. Consistent with such embodiments, processor 610 and/or memory 620 may be located in one or more data centers and/or cloud computing facilities.

In some examples, memory 620 may include non-transitory, tangible, machine readable media that includes executable code that when run by one or more processors (e.g., processor 610) may cause the one or more processors to perform the methods described in further detail herein. For example, as shown, memory 620 includes instructions for a knowledge base Question Answering (QA) module 630 that may be used to implement and/or emulate the systems and models, and/or to implement any of the methods described further herein. In some examples, the knowledge base Question Answering (QA) module 630, may receive an input 640, e.g., such as a question, via a data interface 615. The data interface 615 may be any of a user interface that receives a question, or a communication interface that may receive or retrieve a previously stored question from the database. The knowledge base Question Answering (QA) module 630 may generate an output 650, such as an answer to the input 640.

In one embodiment, memory 620 may store a knowledge base, such as the knowledge base 219 described in FIG. 2. In another embodiment, processor 610 may access a knowledge base stored at a remote server via the communication interface 615.

In some embodiments, the knowledge base Question Answering (QA) module 630 may further includes the ranking module 631 and a generation module 632. The ranking module 631 (which is similar to the ranking module 220 in FIG. 2) is configured to rank and select logical forms associated with each node in a knowledge base graph. The generation module 632 (which is similar to the generation module 230 in FIG. 2) is configured to generate the final logical form, conditioned on the question and the top-k logical forms in the list.

In one implementation, the knowledge base Question Answering (QA) module 630 and its submodules 631-632 may be implemented via software, hardware and/or a combination thereof.

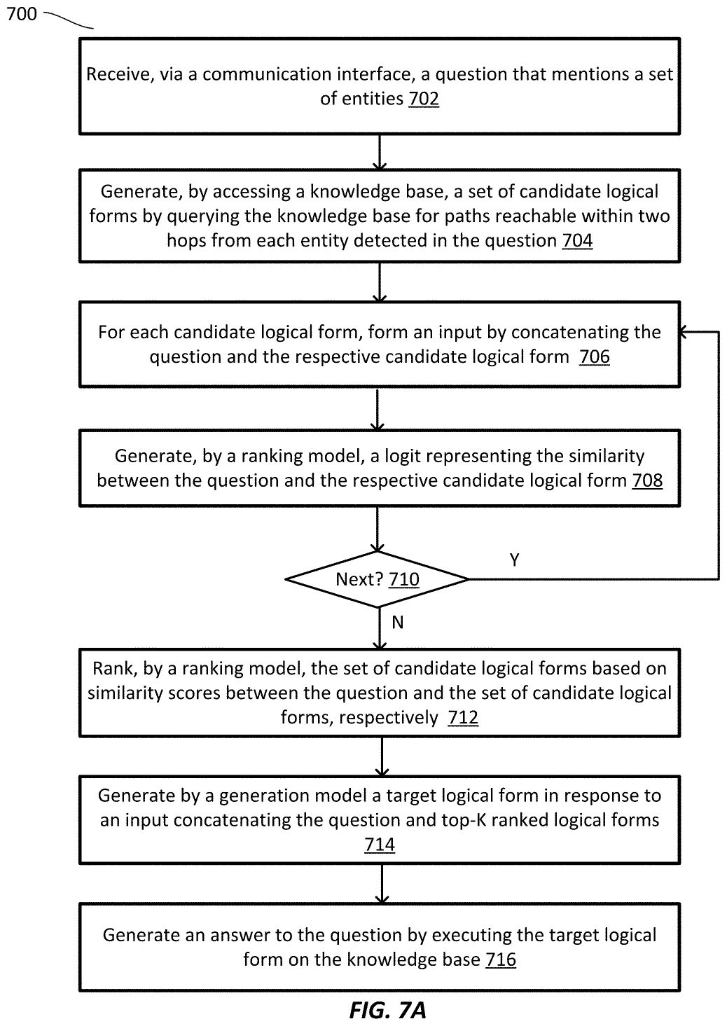

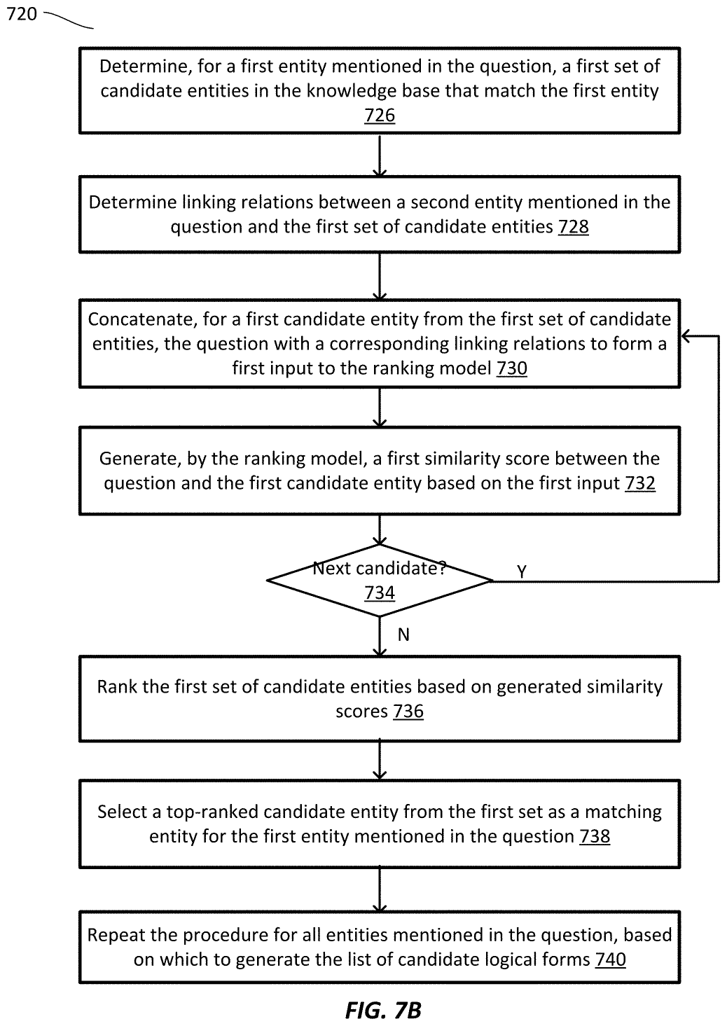

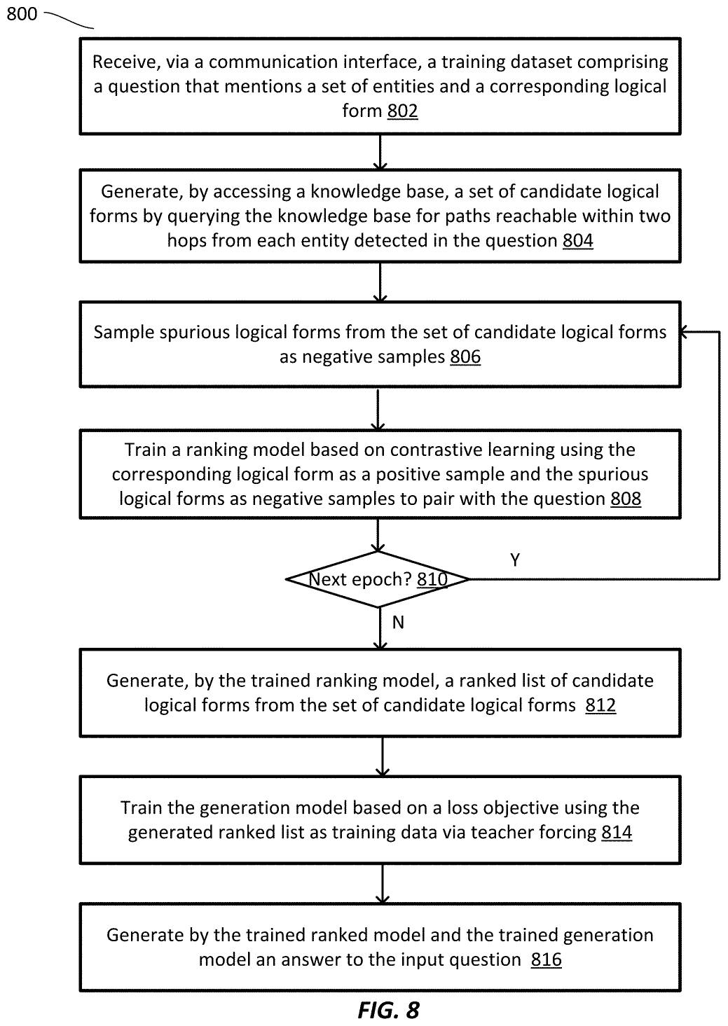

Some examples of computing devices, such as computing device 600 may include non-transitory, tangible, machine readable media that include executable code that when run by one or more processors (e.g., processor 610) may cause the one or more processors to perform the processes of methods 700-800 discussed in relation to FIGS. 7A-8. Some common forms of machine readable media that may include the processes of methods 700-800 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

### Example Workflows

FIG. 7A is a simplified logic flow diagram illustrating an example process 700 of knowledge base question answering using the framework shown in FIGS. 2A-2B, according to embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the knowledge base question answering module 630 (FIG. 6) to perform the task of providing an answer to an input question.

At step 702, a question (e.g., 202 in FIG. 2A) that mentions a set of entities via a communication interface (e.g., 615 in FIG. 6). For example, the question 202 “what is the shortest recording by Samuel Ramey” contains entities “recording,” “Samuel Ramey,” and/or the like.

At step 704, a set of candidate logical forms are generated based on the question by accessing a knowledge base. For example, module 630 may query the knowledge base for paths reachable within two (or more) hops from each entity detected in the question, and convert relation labels along the paths to the set of candidate logical forms, e.g., the s-expressions. Example enumerated candidates can be shown at 215 in FIG. 2B.

At step 706, for each candidate logical form, an input is formed by concatenating the question and a respective candidate logical form. For example, inputs 302a-c shown in FIG. 3 shows that the question is concatenated with each candidate logical form separated by tokens [SEP].

At step 708, a ranking model (e.g., 220 in FIGS. 2A-2B) may generate a logit representing the similarity between the question and the respective candidate logical form.

At step 710, if there is a next logical form in the set of candidate logical forms generated at step 704, method 700 continues and repeats at step 706. Otherwise, if all candidate logical forms have been iterated, method 700 moves on to step 712.

At step 712, the ranking model ranks the set of candidate logical forms based on similarity scores between the question and the set of candidate logical forms, respectively.

At step 714, a generation model (e.g., 230 in FIGS. 2A-2B) generates a target logical form conditioned on the question and a subset of the ranked set of candidate logical forms. For example, the generation model may construct an input to the generation model by concatenating the question and the subset of the ranked set of candidate logical forms, and generate by the generation model the target logical form based on the constructed input. Specifically, as the generation model may comprise a Transformer-based sequence-to-sequence model, the generation model may decode the subset of candidate logical forms using beam search, and then query the knowledge base using each candidate logical form from the subset until a valid answer is returned. In response to determining that no valid answer is returned after exhausting the subset of candidate logical forms, the generation model may determine that a top-ranked candidate logical form in the subset is the target logical form.

At step 716, the module 630 may generate an answer to the question by applying the target logical form on the knowledge base.

FIG. 7B is a simplified logic flow diagram illustrating an example process 720 of entity disambiguation, according to embodiments described herein. One or more of the processes of method 720 may be implemented, at least in part, in the form of executable code stored on non-transitory, tangible, machine-readable media that when run by one or more processors may cause the one or more processors to perform one or more of the processes. In some embodiments, method 720 corresponds to the operation of the knowledge base question answering module 630 (FIG. 6) to perform the task of providing an answer to an input question.

In one embodiment, the process 720 of entity disambiguation may be operated before, after or in concurrence with step 704 of method 700 shown in FIG. 7A such that the set of candidate logical forms generated at step 704 may be further refined with an entity disambiguation process 720.

At step 726, module 630 may determine, for a first entity (e.g., entity “stronger” in question 202 in FIG. 5) mentioned in the question, a first set of candidate entities in the knowledge base that match the first entity.

At step 728, module 630 may determine linking relations between a second entity (e.g., entity “directed”) mentioned in the question and the first set of candidate entities.

At step 730, module 630 may concatenate, for a first candidate entity (e.g., “stronger” in FIG. 5) from the first set of candidate entities, the question with a corresponding linking relation to form a first input to the ranking model. For example, the inputs may be shows at 505a-b in FIG. 5.

At step 732, module 630 may generate, by the ranking model, a first similarity score between the question and the first candidate entity based on the first input.

At step 734, method 720 may determine whether there is a next candidate entity from the set of candidates generated at step 726. If there is a next candidate, method 720 continues and repeats from step 730. Otherwise, if method 720 has exhausted the set of candidates, method 720 proceeds to step 736, at which the module 630 may rank the first set of candidate entities based on generated similarity scores.

At step 736, the module 630 may select a top-ranked candidate entity from the first set as a matching entity for the first entity mentioned in the question.

At step 738, the module 630 may repeat the procedure for all entities mentioned in the question, based on which to generate the list of candidate logical forms. Or alternatively, if the set of candidate logical forms are already generated, method 720 may be performed to refine the set of candidate logical forms.

FIG. 8 is a simplified logic flow diagram illustrating an example process 800 of training the framework in FIGS. 2A-2B for knowledge base question answering, according to embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the knowledge base question answering module 630 (FIG. 6) to perform the task of providing an answer to an input question.

At step 802, the module 630 may receive, via a communication interface (e.g., 615 in FIG. 6), a training dataset comprising a question and a corresponding logical form.

At step 804, the module 630 may generate, by accessing a knowledge base, a set of candidate logical forms based on the question, e.g., by querying the knowledge base for paths reachable within two hops from each entity detected in the question.

At step 806, the module 630 may sample spurious logical forms from the set of candidate logical forms as negative samples, and then train the ranking model based on contrastive learning using the corresponding logical form as a positive sample and the spurious logical forms as negative samples to pair with the question at step 808. For example, the module 630 may randomly sample va subset of negative samples from the set of candidate logical forms, form a positive input of the question and the corresponding logical form, and then form a plurality of negative inputs from the question and the subset of negative samples. The ranking model is then trained using the positive input and the plurality of negative inputs for a number of timesteps at a beginning of training. Next, one or more negative samples that are confusing (spurious) to the ranking model are selected from the subset of negative samples during training. A set of negative inputs are formed by pairing the question and the one or more negative samples. Then the ranking model is trained by using the positive input and the set of negative inputs at a later stage of training.

For example, the contrastive loss is computed at step 808. The ranking model generates a first logit representing a first similarity score between the question and the positive sample, and a plurality of logits representing similarity scores between the question and the plurality of negative samples, respectively. The contrastive loss is then computed based on the first logit and the plurality of logits.

In one embodiment, the ranking model may be further trained for entity disambiguity. For example, each training question may mention a set of entities, and for a first entity mentioned in the question, a first set of candidate entities are determined in the knowledge base that match the first entity. Linking relations between a second entity mentioned in the question and the first set of candidate entities are thus determined, as shown at 502a-b in FIG. 5. A positive input pair may then be formed based on the question and a corresponding linking relation, and a plurality of negative input pairs may then be formed based on the question and the determined linking relations. The ranking model may then be trained via contrastive learning based on the positive input pair and the plurality of negative input pairs.

At step 810, method 720 may determine whether a next training epoch is needed. If yes, method 720 continues and repeats from step 806. Otherwise, method 720 finishes the training of the ranking model, and moves on to step 812, at which the trained ranking model generates a ranked list of candidate logical forms from the set of candidate logical forms as training data for the generation model.

At step 814, the generation model is trained based on a loss objective using the generated ranked list as training data. For example, the generation model may generate a second target logical form from the generated ranked list of candidate logical forms at a next training step. A cross-entropy loss is computed between the second target logical form and the first target logical form as ground truth.

At step 816, when a testing question is received, an answer is generated by the trained ranking model and the trained generation model. For example, the trained ranking model and the trained generation model may generate a target logical form for the testing question, which is applied on the knowledge base to generate the answer.

### Example Performance

The knowledge base question answering (KBQA) system described herein may be trained and tested on GRAILQA (Gu et al., 2021), a KBQA dataset focused on evaluating the generalization capabilities; and on WEBQSP.

Specifically, GRAILQA is the first dataset that evaluates the zero-shot generalization. GRAILQA contains 64,331 questions in total and carefully splits the data so as to evaluate three levels of generalization in the task of KBQA, including i.i.d. setting, compositional setting (generalizing to un-seen composition), and zero-shot setting (generalizing to unseen KB schema). Examples of compositional generalization and zero-shot generalization can be similar to the example shown in FIG. 1. The fraction of each setting in the test set is 25%, 25%, and 50%, respectively. Aside from the generalization challenge, GRAILQA also presents additional difficulty in terms of the large number of involved entities/relations, complex compositionality in the logical forms (up to 4 hops), and noisiness of the entities mentioned in questions.

In one embodiment, each entity mention is linked to an entity node in KB using the approach described in relation to FIG. 5. A BERT-NER systems is used to detect mention spans in the question. For each mention span, the span is matched with surface forms in the FACC1 project (described in Gabrilovich et al., FACC1: Freebase annotation of clueweb corpora, version 1, 2013), rank the matched entities using popularity score, and retain the top-5 entity candidates. Lastly, the disambiguation model trained on GRAILQA is used to select only one entity for each mention. An entity ambulation model is initiated from BERT-base-uncased model provided by huggingface library (described in Wolf et al., Transformers: State-of-the-art natural language processing, in Proceedings of the Conference on Empirical Methods in Natural Language Processing: System Demonstrations (EMNLP Demo Track), 2020), and finetuned for 3 epochs with a learning rate of 1e−5 and a batch size of 8.

When training the ranker, 96 negative candidates are sampled using the strategy described in relation to FIG. 3. The ranking model is finetuned from BERT-base-uncased for 3 epochs using a learning rate of 1e−5 and a batch size of 8. Bootstrapping is performed after every epoch. It is also noteworthy that teacher-forcing is performed when training the ranking, i.e., ground truth entity linking is used for enumerating training candidates.

The generation model may be based on T5-base (described in Raffel et al., 2020). The top-5 candidates returned by the ranker are used and the T5 generation model is fine tuned for 10 epochs using a learning rate of 3e−5 and a batch size of 8.

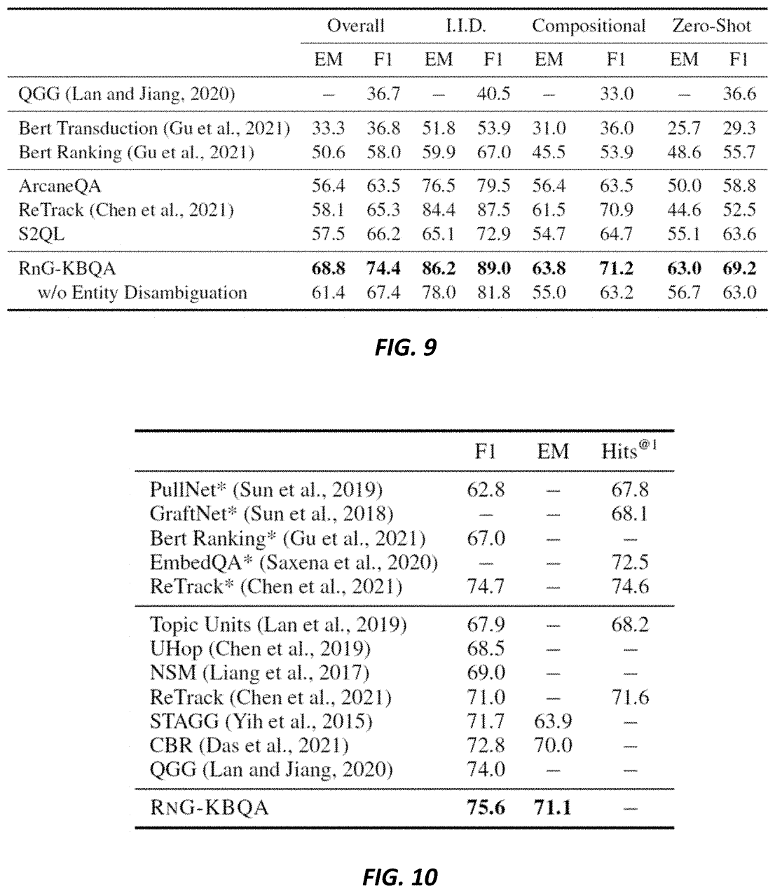

For GRAILQA, exact match (EX) and F1 score (F1) are used as the metrics for performance valuation all of which are computed using official evaluation script. FIG. 9 summarizes the results on the GRAILQA dataset. The results of other approaches include QGG (described in Lan et al., Query graph generation for answering multi-hop complex questions from knowledge bases, in Proceedings of the 58th Annual Meeting of the Association for Computational Linguistics, 2020), BERT transduction and BERT ranking (Gu et al.), ReTrack (in Chen et al.), which are directly taken from the leaderboard. Overall, the KBQA system described herein achieves the best performance on GRAILQA dataset, achieving 68.8 EM score and 74.4 F1 score in aggregation. This exhibits a large margin over the other approaches: the instant approach outperforms ReTrack by 10.7 EM and 8.2 F1.

Furthermore, KB QA performs generally well for all three levels of generalization and is particularly strong in zero-shot setting. The KBQA is slightly better than ReTrack and substantially better than all the other approaches in i.i.d. set-ting and compositional setting. However, ReTrack fails in generalizing to unseen KB Schema items and only achieves poor performance in zero-shot setting, whereas our approach is generalizable and beats ReTrack with a margin of 16.1 F1 score.

To directly compare the effectiveness of our rank-and-generate framework against rank-only baseline (BERT Ranking), the performance of a variant of RNG-KBQA without the entity-disambiguation model is also provide. In this variant the entity linking results are used provided by the authors of Gu et al. (2021). Under the same entity linking performance, the ranking-and-generation framework is able to improve the performance by 9.7% EM and 8.2 F1. Furthermore, even with-out the entity-disambiguation module, the proposed model still substantially outperforms all other approaches, even when some of them (e.g., ReTrack) use a better entity linking system.

In one embodiment, data experiments are carried based on WEBQSP, which is a popular dataset which evaluates KBQA approaches in i.i.d. setting. It contains 4,937 question in total and requires reasoning chains with up to 2 hops. Since there is no official development split for this dataset, 200 examples are randomly sampled from the training set for validation.

Implementation Detail For experiments on WEB QSP include using ELQ (Li et al., Efficient one-pass end-to-end entity linking for questions, in Proceedings of EMNLP, 2020) as the entity linker, which is trained on WEBQSP dataset to perform entity detection and entity linking, since it produces more precise entity linking results and hence leads to less number of candidate logical forms for each question. Because ELQ always links a mention to only one entity, no entity-disambiguation step is needed for WEB QSP dataset. Similarly, the logical form ranker is initiated using BERT-base-uncased, and the generator using T5-base. 96 negative candidates are sampled for each question, and feed the top-5 candidates to the generation model. The ranker is trained for 10 epochs and bootstrapping is run every 2 epochs; the generator is trained for 20 epochs.

In one embodiment, F1 score is used as the main evaluation metric. In addition, for approaches that are able to select entity sets as answers, the exact match (EM) numbers used in the official evaluation. For information retrieval based approaches that can only predict a single entity, Hits @ 1 metric (if the predicted entity is in the ground truth entity set) is used, which is considered as a loose approximation of exact match.

For baseline approaches, results reported in corresponding original papers: PullNet and GraftNet from Sun et al.; BERT Ranking from Gu et al; EmbedQA from Saxena et al., Improving multi-hop question answering over knowledge graphs using knowledge base embeddings, in Proceedings of the 58th Annual Meeting of the Association for Computational Linguistics, 2020; Topic Units from Lan et al.; UHop from Chen et al.; NSM from Liang et al.; STAGG from Yih et al.; CBR from Das et al., Case-based reasoning for natural language queries over knowledge bases. arXiv preprint arXiv:2104.08762, 2021, and/or the like. As shown in FIG. 10, RNG-KBQA achieves 75.6 F1, surpassing the prior state-of-the-art (QGG) by 1.6. The KBQA approach also achieves the best EM score of 71.1, surpassing CBR (Das et al.). The performance of KBQA approach obtained using ELQ-predicted entity linking outperforms all the prior methods, even if they are allowed to use oracle entity linking annotations (denoted as * in the top section). It is also noteworthy that both CBR and QGG, the two methods achieving strong performance closest to KBQA, use an entity linker with equal or better performance compared to ours. In particular, CBR also uses ELQ for entity linking. QGG uses an entity linker achieving 85.2 entity linking F1 (calculated using public available code). To summarize, the results on WEBQSP suggest that, in addition to outstanding generalization capability, KBQA is also as strong in solving simpler questions in i.i.d. setting.

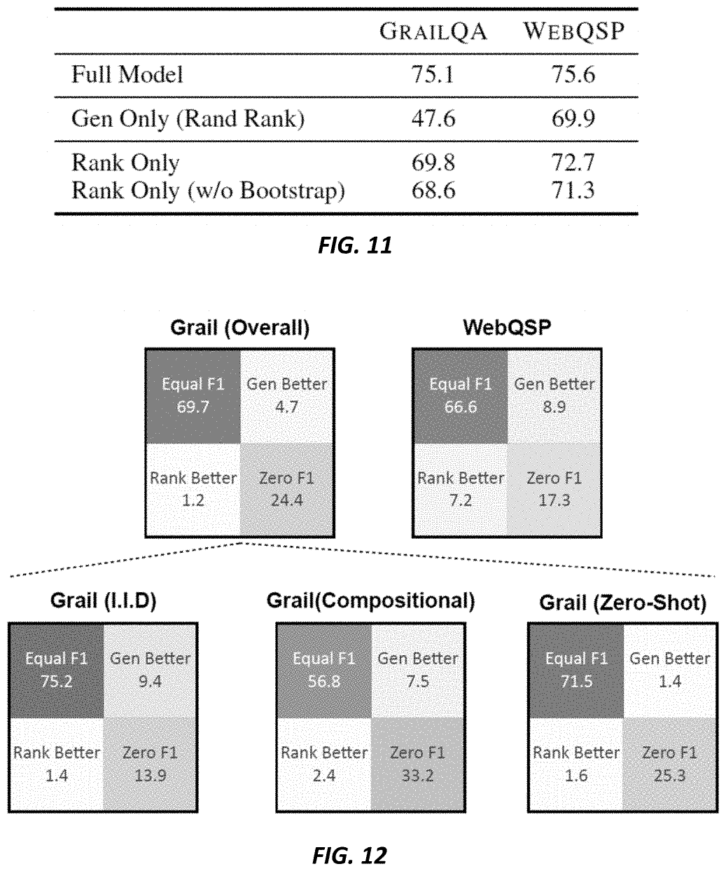

The performance of KBQA is further compared against incomplete ablations in FIG. 11. A generation-only (Gen Only) model is derived from our base model by replacing the trained ranker with a random ranker, which leads to a performance drop of 27.5 and 5.7 on GRAILQA and WEBQSP, respectively. The performance deterioration is especially sharp on GRAILQA as it requires generalizing to unseen KB schema items, for which the generator typically needs to be based on a good set of candidates to be effective. To test the effects of the generation step, the performance of a ranking-only variant (directly using the top-ranked candidate) against the performance of the full model is derived. As shown in FIG. 11, the generation model is able to remedy some cases not addressable by the ranking model alone, which boosts the performance by 5.3 on GRAILQA and 2.9 on WEBQSP.

The performance of a ranking model trained without bootstrapping strategy is further illustrated. The performance of this variant lags its counterpart by 1.2 and 1.4 on GRAILQA and WEB QSP, respectively. The boot-strapping strategy is indeed helpful for training the ranker to better distinguish spurious candidates.

By comparing outputs of ranking model and generation model, the benefit of adding a generation stage on top of the ranking step on previous result sections is shown. Here, FIG. 12 provides a more detailed comparison is provided between the outputs of ranking model and generation model. FIG. 12 presents the “comparison matrices” showing the fractions of questions where top left: the top ranking prediction and top generation prediction achieves equal F1 (must be greater than 0), top right: the top generation prediction is better, bottom left: the top ranking prediction is better, bottom right: they both fail (achieving a 0 F1). The generator retains the ranking predictions without any modifications for most of the time. For 4.7% and 8.9% of the questions from GRAILQA and WEBQSP, respectively, the generator is able to fix the top-ranked candidates and improves the performance. Although generator can make mistakes in non-negligible fraction of examples on WEBQSP, it is mostly caused by introducing false constraints

The bottom row of FIG. 12 also shows the break down by types of generalization on GRAILQA. Generation stage is more helpful in i.i.d. and com-positional setting, but less effective in zero-shot setting, as it involves unseen relations that are usually hard to generate.

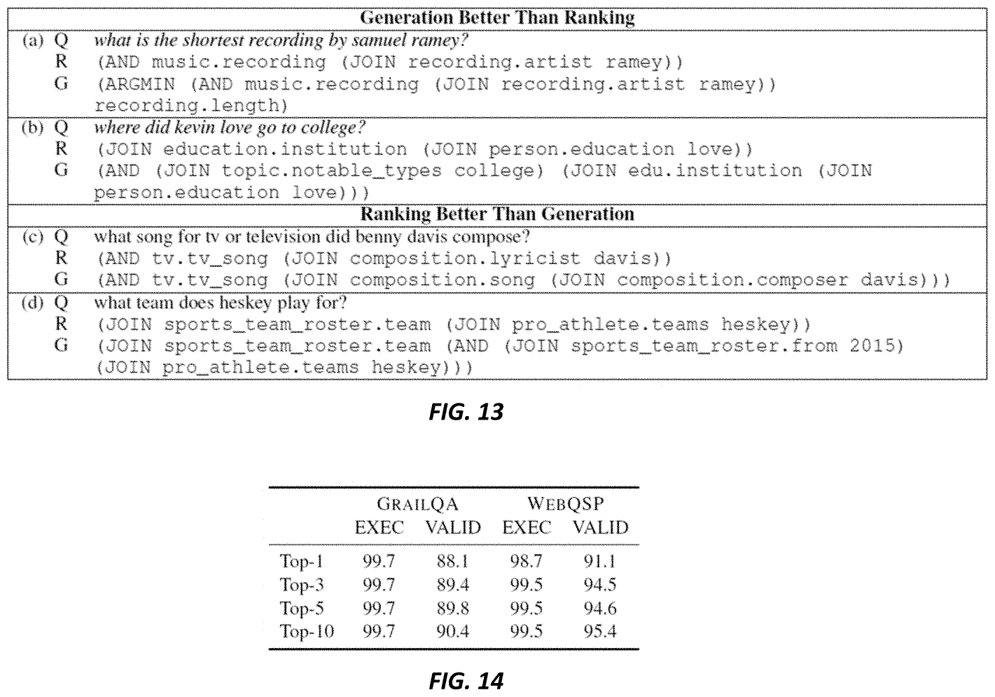

FIG. 13 shows output examples of ranking model and generation model. As suggested by ex-ample (a), the generation model can truly remedy some missing operations (ARGMIN) not supported when enumerating. In addition, it is capable of patching the top-ranked candidate with implicit constraints: the (JOIN topic.notable_types college) in (b) is not explicitly stated, and the NER system fails to recognize college as an entity. As in example (c), the generation model makes a worse prediction sometimes because it prefers another prediction in the top-ranked list due to inherent ambiguity in the question. It can also fail when falsely adding a constraint which results in empty answer (d).

Executability of Generated Logical Forms is adopted to further measure the quality of generated outputs. FIG. 14 shows executable rate (producing an executable logical forms) and valid rate (producing a logical form that yields non-empty answer) among the top-k decoded list. Nearly all the top-1 generated logical forms are executable. This suggests that the generation model can indeed produce high-quality predictions in terms of syntactic correctness and consistency with KB. As the beam size increases, more valid logical forms can be found in the top-k list, which the inference procedure can benefit from.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of knowledge base question answering, the method comprising:
receiving, via a communication interface, a question that mentions a set of entities;
generating, by accessing a knowledge base, a set of candidate logical forms based on the question;
ranking, by a ranking model, the set of candidate logical forms based on similarity scores between the question and the set of candidate logical forms, respectively;
generating, by a generation model, a target logical form conditioned on the question and a subset of the ranked set of candidate logical forms; and
generating an answer to the question by applying the target logical form on the knowledge base.

2. The method of claim 1, wherein the set of candidate logical forms is generated by:
querying the knowledge base for paths reachable within two hops from each entity detected in the question; and
converting relation labels along the paths to the set of candidate logical forms.

3. The method of claim 1, wherein the ranking model comprises a language model based bi-encoder and a linear projection layer.

4. The method of claim 1, wherein the ranking, by the ranking model, the set of candidate logical forms further comprises:
forming an input for the ranking model by concatenating the question and a first candidate logical form from the set of candidate logical forms; and
generating, by the ranking model, a first logit representing a similarity score between the question and the first candidate logical form.

5. The method of claim 1, wherein the generation model is a transformer-based sequence-to-sequence model.

6. The method of claim 1, wherein the generating, by the generation model, the target logical form further comprises:
constructing an input to the generation model by concatenating the question and the subset of the ranked set of candidate logical forms; and
generating by the generation model the target logical form based on the constructed input.

7. The method of claim 6, further comprising:
decoding the subset of candidate logical forms using beam search; and
querying the knowledge base using each candidate logical form from the subset until a valid answer is returned.

8. The method of claim 7, further comprising:
in response to determining that no valid answer is returned after exhausting the subset of candidate logical forms, determining that a top-ranked candidate logical form in the subset is the target logical form.

9. The method of claim 1, further comprising:
determining, for a first entity mentioned in the question, a first set of candidate entities in the knowledge base that match the first entity; and
determining linking relations between a second entity mentioned in the question and the first set of candidate entities.

10. The method of claim 9, further comprising:
concatenating, for a first candidate entity from the first set of candidate entities, the question with a corresponding linking relations to form a first input to the ranking model;
generating, by the ranking model, a first similarity score between the question and the first candidate entity based on the first input;
ranking the first set of candidate entities based on generated similarity scores; and
selecting a top-ranked candidate entity from the first set as a matching entity for the first entity mentioned in the question.

11. A system for knowledge base question answering, the system comprising:
a communication interface receiving a question that mentions a set of entities;
a memory storing a plurality of processor-executable instructions; and
a processor reading and executing the instructions from the memory to perform operations comprising:
generating, by accessing a knowledge base, a set of candidate logical forms based on the question;
ranking, by a ranking model, the set of candidate logical forms based on similarity scores between the question and the set of candidate logical forms, respectively;
generating, by a generation model, a target logical form conditioned on the question and a subset of the ranked set of candidate logical forms; and
generating an answer to the question by applying the target logical form on the knowledge base.

12. The system of claim 11, wherein the set of candidate logical forms is generated by:
querying the knowledge base for paths reachable within two hops from each entity detected in the question; and
converting relation labels along the paths to the set of candidate logical forms.

13. The system of claim 11, wherein the ranking model comprises a language model based bi-encoder and a linear projection layer.

14. The system of claim 11, wherein the ranking, by the ranking model, the set of candidate logical forms further comprises:
forming an input for the ranking model by concatenating the question and a first candidate logical form from the set of candidate logical forms; and
generating, by the ranking model, a first logit representing a similarity score between the question and the first candidate logical form.

15. The system of claim 11, wherein the generation model is a transformer-based sequence-to-sequence model.

16. The system of claim 11, wherein the operation of generating, by the generation model, the target logical form further comprises:
constructing an input to the generation model by concatenating the question and the subset of the ranked set of candidate logical forms; and
generating by the generation model the target logical form based on the constructed input.

17. The system of claim 16, wherein the operations further comprise:
decoding the subset of candidate logical forms using beam search; and
querying the knowledge base using each candidate logical form from the subset until a valid answer is returned.

18. The system of claim 17, wherein the operations further comprise:
in response to determining that no valid answer is returned after exhausting the subset of candidate logical forms, determining that a top-ranked candidate logical form in the subset is the target logical form.

19. The system of claim 11, wherein the operations further comprise:
determining, for a first entity mentioned in the question, a first set of candidate entities in the knowledge base that match the first entity;
determining linking relations between a second entity mentioned in the question and the first set of candidate entities;
concatenating, for a first candidate entity from the first set of candidate entities, the question with a corresponding linking relations to form a first input to the ranking model;
generating, by the ranking model, a first similarity score between the question and the first candidate entity based on the first input;
ranking the first set of candidate entities based on generated similarity scores; and
selecting a top-ranked candidate entity from the first set as a matching entity for the first entity mentioned in the question.

20. A processor-readable non-transitory storage medium storing a plurality of processor-executable instructions for knowledge base question answering, the instructions being executed by one or more processors to perform operations comprising:
receiving, via a communication interface, a question that mentions a set of entities;
generating, by accessing a knowledge base, a set of candidate logical forms based on the question;
ranking, by a ranking model, the set of candidate logical forms based on similarity scores between the question and the set of candidate logical forms, respectively;
generating, by a generation model, a target logical form conditioned on the question and a subset of the ranked set of candidate logical forms; and
generating an answer to the question by applying the target logical form on the knowledge base.
